(19) United States
(12) Patent Application Publication
(10) Pub. No.: US 2004/0203694 A1
(43) Pub. Date: Oct. 14, 2004

(54) Reconfigurable wireless-enabled network device

(76) Inventors: Samuel L.C. Wong, San Jose, CA (US); Ram C. Nalla, San Jose, CA (US); Alexander V. Reshetov, San Jose, CA (US); Alexei Soupikov, Nizhny Novgorod (RU); James T. Hurley, Pleasanton, CA (US)

Correspondence Address: Timothy N. Trop, TROP, PRUNER & HU, PC., STE 100, 8554 KATY FWY, HOUSTON, TX, 77024-1841, US

(21) Appl. No.: 10/274,574

(22) Filed: Oct. 21, 2002

(51) Int. Cl. H04Q 7/00

(52) U.S. Cl. 455/419; 455/553.1

(57) ABSTRACT

For a processor-based device capable of network communications, a workload associated with a wireless link to a network may be partitioned into software and hardware implementable portions based on a link communication profile. In response to a different link communication profile, the workload may be re-configured to simultaneously support another wireless link protocol different than that of the configured wireless link.

### BACKGROUND

This invention relates generally to a processor-based device capable of wireless communications, and more particularly to reconfigurable wireless-enabled network devices.

Using a wireless link, a processor-based system may communicate with a variety of other network devices over a network. A wireless link refers to a receiver/transmitter pair across a wireless-enabled processor-based device and an access point in some cases. In a wireless link, connections may be provided to one or many wireless-enabled network communication devices coupled to a communication network, for example, a local area network (LAN) capable of processing wireless network communications. A selected one or few of multiplicity of wired/wireless network communication protocols may establish a wireless link. For a communication system, such a wireless link may enable voice, video, audio data transfer in point-to-point or point to multi-point communications, as few examples. In other architectures, such as a peer-to-peer architecture, however, a communication system may not involve any access points.

For providing a wireless communication on a wireless link, it is often the case that either the same protocol may be implemented differently in different geo-political regions, or that completely different protocols achieving substantially similar results are implemented in different parts of the world. As a result, for wireless-enabled processor-based products based on hardware implementations, either vendor may target a specific region with a particular solution, or the vendor may support many potential substantially similar or radically different products to address a worldwide customer base. In addition, the end-user may possess separate devices for different geo-political region wherein that customer travels.

Thus, there is a continuing need for better ways to simultaneously support different wireless links on a network communication device.

### BRIEF DESCRIPTION OF THE DRAWINGS

FIG. 1 is a schematic depiction of a wireless network in accordance with one embodiment of the present invention.

FIG. 2 is a depiction of a host device according to one embodiment of the present invention;

FIG. 3 is a depiction of a device driver interfacing with a communication interface that includes a programmable device consistent with an embodiment of the present invention;

FIG. 4A is a flow chart for software for the host device shown in FIG. 1 in accordance with one embodiment of the present invention; and

FIG. 4B is a flow chart for a driver included in the host device shown in FIG. 1 according to one embodiment of the present invention.

### DETAILED DESCRIPTION

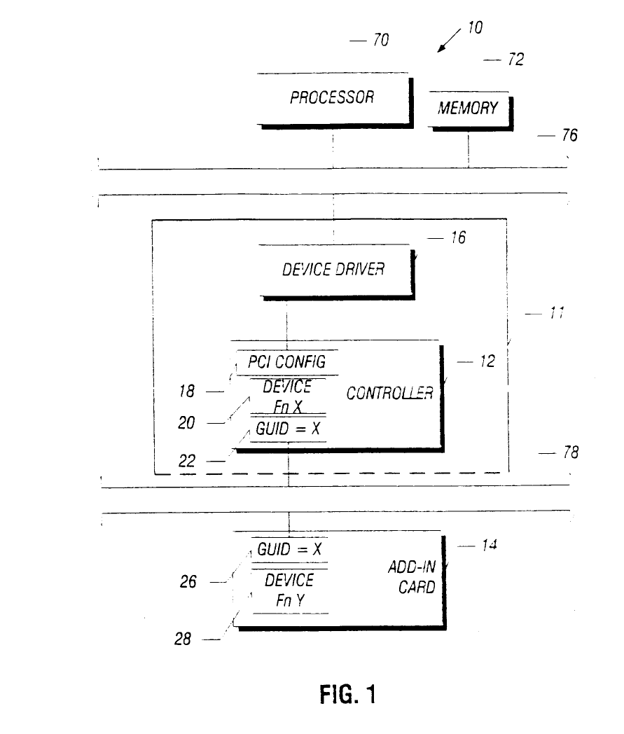

Referring to FIG. 1, a wireless network 20 may include a host device 30 capable of wirelessly communicating network communications over a wireless link to an access point 40 in accordance with one embodiment of the present invention. In some embodiments, a wireless link is a receiver/transmitter pair that provides point-to-point communications between two host devices 30 one of which may be the access point 40. In another embodiment involving peer-to-peer communications between the host device 30 and a wireless-enabled network communication device, none of the two devices may be the access point 40. In other embodiments, the wireless link may provide point to multi-point communications from a wireless-enabled network communication device, which may be the access point 40 to multiple host devices 30. Using a programmability and reconfigurability feature without modifying hardware, different wireless links may be simultaneously supported within the host device 30 or the access point 40, enabling a variety of wireless communications in some embodiments of the present invention. Examples of the wireless link include a cell phone link, a computer to a cell phone link and a wireless local area network (WLAN) link. Examples of the host device 30 include a processor-based device, such as a personal computer, and a variety of handheld, portable, or mobile devices.

Regardless of the type of the wireless link and/or communications thereon, data transfers over the wireless link may take place in units of data, such data packets in one embodiment. However, significant data transmission characteristics of network communications on wireless link may be determined by a particular wireless communication standard being used. For the purposes of providing wireless network communications, short-range wireless links may be used in one embodiment. As an example, a wireless communication over any one of these wireless links may be defined by a standard, such as the Instute of Electrical and Electronics Engineers (IEEE) 802.11a standard, IEEE Std. 802.11, published in 1999, and IEEE Std. 802.11b, published as a supplement to the IEEE Std. 802.11 in 1999. Another wireless communication over such a wireless link may use a standard called Bluetooth standard, which is set forth by the Bluetooth Special Interest Group (SIG) in a specification entitled, “Specification of the Bluetooth System, Volume 1: Core and Volume 2: Profiles, ” version 1.1, February 2001.

Consistent with one embodiment of the present invention, the host device 30 may comprise an antenna 45a for communication with another wireless-enabled network communication device which may be the access point 40 that may include use an antenna 45b communicatively coupled thereto for receiving and transmitting wireless network communications in the wireless link over an air interface 50. An example of the antenna 45 is a dipole antenna. Likewise, examples of wireless network communications include cellular telephony, satellite broadcast, nomadic computing, and wireless LAN (e.g., the IEEE 802.1a/b standards based protocols that may form an indoor wireless LAN). While the 802.11b operates at the 2.4 GHz Industrial, Scientific and Medical (ISM) frequency band and delivers data at 1, 2, 5.5, and 11 megabits per second (mbps), the 802.11a operates at the 5 GHz frequency and delivers data to a maximum of 54 mbps.

According to one embodiment, the wireless link may provide an access to a network, such as a local area network (LAN) 60. One or many processor-based systems, such as a desktop computer, a laptop computer or any of a variety of other computers, peripherals, processor-based devices, cellular phones, portable devices, and personal digital assistants (PDAs) may be networked to the LAN 60 that may be capable of wireless connectivity in some embodiments. In addition, a server 65 may manage the LAN 60 that may further be connected via a router 70 to one or many networks, such as Internet 80. Essentially, at the host device 30, in one embodiment, a workload associated with a wireless link may be partitioned into software and hardware implementable portions based on a link communication profile. In one embodiment the link communication profile may be a name of the standard, e.g., an 802.11a profile. In another embodiment, the link communication profile may refer to one or more features associated with a particular wireless protocol. Examples of such features include channel information, signal power range, and bit rate of transmission.

At some point, however, one or more link communication profiles may be loaded in the host device 30. A specific link communication profile may be selected in one embodiment. In another embodiment, a link communication profile may have been preconfigured as a default profile. For some embodiments, the link communication profile may be automatically detected. However, in response to an input or a selection indicative of a different link communication profile, the workload associated with the wireless link may be reconfigured for the host device 30, in some embodiments of the present invention.

Encompassing one or more wireless/wired network communication protocols and overhead for undertaking communications in a specific wireless link over a communication network, one embodiment collectively refers to such an entity as a workload that may be desirably partitioned. Of course, a variety of different aggregations may define a partitionable workload in other embodiments of the present invention. In one embodiment, a medium access control (MAC) and a physical (PHY) layer interface to a wireless medium may be partitioned for a wireless link into software and hardware implementable portions. Based on a selected or an active link communication profile, either one of these portions and/or associated functionality may be subsequently distributed in the host device 30 as software and hardware implementable portions. Instead of providing all the MAC functionality at the access point 40 as conventionally done in wireless communication systems, a desired level of MAC functionality may be programmed in the access point 40, or alternately in the host device 30. Specifically, in one embodiment, some MAC protocol portion may be provided in software at the host device 30 while the other MAC protocol portion may be implemented in hardware.

As an example, the 802.11a/b standards specify two network protocol layers—the MAC part of a logical link control layer and the PHY layer. The MAC layer is responsible for the formation of transmit packets and parsing of received packets, as well as other functions including transmission scheduling, authentication/de-authentication, network associating. The primary operations of the MAC layer may be characterized by timing measurement, table searching, deciding branching and executing an encryption algorithm, as some examples. The PHY layer may specify low-level packet formats and methods of signal/channel coding and modulation. The associated symbol-wise and bit-wise operations may be incorporated into a digital computation pipeline, running at a baseband frequency (e.g., 1 and 11 MHz, respectively).

In the 802.11a/b standards, the host device 30 may be programmed into—a station (e.g., the host device 30) or the access point 40. In any event, for the host device 30, a digital front-end may be responsible for signal detection and synchronization, which may be operated at the over-sampling rate of 44 MHz (4×11 MHz) according to one embodiment of the present invention. Analog and high-speed digital components may operate above the baseband frequency, such as the intermediate frequency (IF) greater than 200 MHz. In one embodiment, the PHY layer is a data flow pipeline, and the MAC layer is a web of interdependent control state machines (processes). The MAC functionality of governing multiple clients' concurrent access control (e.g., w/o—Quality of Service (QoS)) and connecting to a wired network (e.g., Ethernet) to form a much larger network may be partitioned within the host device 30.

To this end, the host device 30 may include a controller 90 and an interface, such as one or more internal bus(es) 95 to operably couple the controller 90 to drivers 100. The drivers 100 may communicate via the internal bus(es) 95 a host input/output (I/O) interface 105 with a communication interface 110. The controller 90, according to one embodiment, may include a processor 125, a primary interface 130 and a system memory 140. A basic input/output system (BIOS) 135 may be included for the host device 30 to enable a personal computer environment in one embodiment.

At some point, a wireless link application (APP) 142 may be loaded into the system memory 140 to enable a desired reconfiguration of a wireless link, identifying a particular link communication profile to the host device 30. In some embodiments, the wireless link application 142 may be installed into the host device 30. In other embodiments, a user or a vendor may install the wireless link application 142 at a later point, for example. In the host device 30, a secondary interface 150 may operably couple the internal bus(es) 95 to a drive controller 160 that may further be associated with a hard disk drive (HDD) 155.

By advantageously using an ability to reconfigure and adapt the host device 30, in some embodiments of the present invention, a regional variance of a wireless/wired network communication protocol and/or a wireless service vendor may be accounted for. Accordingly, the host device 30 may simultaneously support one or more wireless/wired network communication protocols because a desired wireless link may be made available for use with a particular application and/or wireless link. In one embodiment, for each of different wireless links, a different analog front end may be provided in the host device 30.

In operation, wireless link application 142 may be available to a user via a display 170 operable through a display controller 175, controllably interfacing with both the primary and secondary interfaces 130, 150. For example, one or more user interface templates may be displayed on display 170 by the wireless link application 142, enabling a selection of a particular wireless link or one or more features associated with a particular wireless link being selected. Some user interface templates may include configuring and connection monitoring templates, as one example.

Based on a particular wireless link, the communication interface 110 may be adapted, in one embodiment, to handle a workload related to a link communication profile for the particular wireless link. For the purposes of adapting the communication interface 110, the drivers 100 may include a network driver 180 appropriately stored in a storage device 190 in accordance with one embodiment. In other embodiments, the network driver 180 may be included in the HDD 155. To support multiple network protocols, the drivers 100 may further include a device driver 195, enabling the communication interface 110 to accommodate one or more wireless/wired communication protocols for a wireless communication in a wireless link. In one embodiment, the device driver 195 is a network driver interface specification (NDIS) Windows® device driver capable of adapting the communication interface 110 to support both Transmission Control Protocol/Internet Protocol (TCP/IP) and Internet Packet Exchange (IPX) connections.

The device driver 195 may include a protocol manager 200 that accepts requests from the network driver 180 (at a transport layer) and passes these requests to the communication interface 110 (at a data link layer). A MAC protocol 205 and a PHY protocol 210 may be included for a wireless connectivity with either the access point 40 being fixed, portable, or moving stations such as the host device 30 within a local area. However, the MAC protocol 205 may be modularized into three sublayers including upper MAC, middle MAC, and lower MAC based on the type of operations in one embodiment. Each sublayer may be responsible for different latency requirements. For instance, these latencies may be the time used by the MAC protocol 205 to process packets in a type of a frame. Examples of the frame type include control frames, management frames, and data frames typically having latencies in the range of microseconds, milliseconds, and tenth-seconds, respectively.

To provide a wireless link programmability and reconfigurability feature within the host device 30, the communication interface 110 may include a programmable device 225. The programmable device 225 may be programmed based on a link communication profile and a workload, in one embodiment, adapting the host device 30 in response to an indication from the device driver 195. The programmable device 225 may comprise logic controlling one or more configurable bits. The device driver 195 may enable programming of these one or more bits. Specifically, in response to a different link communication profile, by reprogramming the programmable device 225 one or more wireless communication protocols may be accommodated for a wireless communication over a wireless link. Based on the programmable device 225, the software and hardware implementable portions of the workload may be adjusted to provide a flexible wireless communication platform out of a personal computer.

A selected one or few of available chipsets at the host device 30 may be provisioned to include the programmable device 225 in some embodiments of the present invention. Using the device driver 195, the drivers 100 may send or receive control signals via a host I/O interface 105 from/to the programmable device 225 in one case. Once the programmable device 225 is appropriately programmed, i.e., corresponding to a selected wireless link, then the communication interface 110 may use a wireless network interface 230a operably coupled to the antenna 45a for establishing wireless network communications. In addition, a wired network interface 230b may be provided to handle wired network communications.

For the purposes of storing one or more link communication profiles which may be entered, selected, identified, received or detected at the host device 30, a link profile database 165 may be provided within the communication interface 110. The link profile database 165 may maintain one or more link communication profiles with associated attributes for use with the wireless link application 142. When a link communication profile (LCP) 167a corresponding to a specific wireless link is selected, the host device 30 may access associated wireless link attributes based on an indication of current selection in the link profile database 165. Likewise, when a different link communication profile (LCP) 167b is indicated, the wireless link application 142 may access a different set of wireless link attributes in the link profile database 165 corresponding to the different link communication profile 167b being a current link communication profile.

Consistent with one embodiment, the access point 40 may comprise an analog front-end 240, processing any wireless network communications arriving or having sent through the antenna 45b. An analog-to-digital and digital-to-analog converter 242 may further be deployed for digital signal processing from a wireless tranceiver 244, receiving digital data transmission, such as in packets over the LAN 60.

In operation, the device driver 195 may extract from a wireless link protocol and channel information associated with a particular wireless communication. Based on the protocol and channel information, one or more wireless/wired network communication protocols may be cooperatively handled in the host device 30. Responsive to an indication from the wireless link application 142, the device driver 195 may enable programming of the communication interface 110. The indication, which may be based on the link communication profile 167a, may cause the controller 90 to operate as a medium access controller in one embodiment.

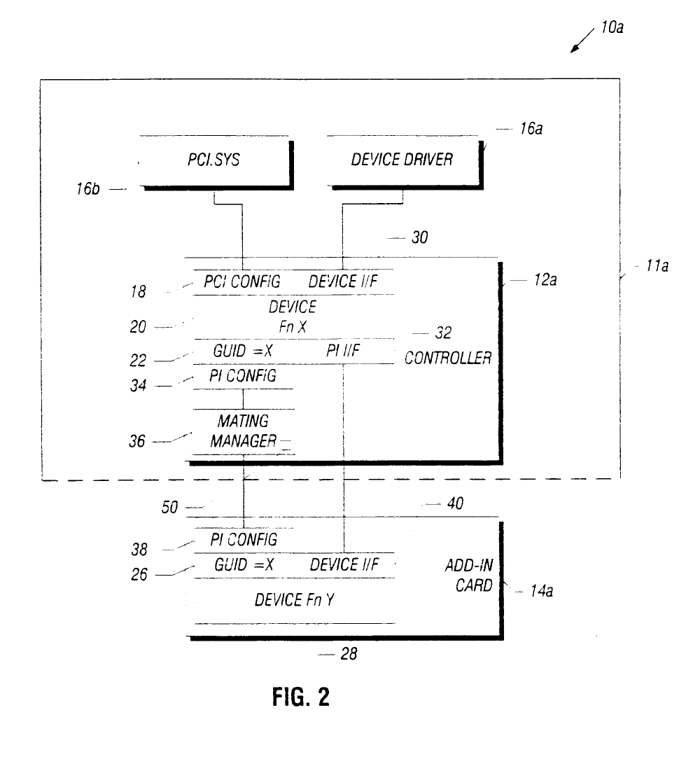

Referring to FIG. 2, a user platform 275, as based for example on a personal computer (PC) architecture, may be used with an architectural framework 280 to implement the host device 30, in one embodiment. This combination of the user platform 275 and the architectural framework 280 may enable a flexible wireless communication platform, providing a reconfigureable wireless communication architecture that allows a wireless communication to be handled based on a selected wireless link. More particularly, a wireless communication may be selectively provided on one or more communication channels in the wireless link where each of the communication channels may operate in a different frequency range.

To enable programming and reprogramming either to reconfigure or dynamically adapt the host device 30, the programmable device 225 may include a direct memory access (DMA) engine 325 and a set of buffers 330. On the user platform 275, the architectural framework 280 may incorporate one or more applications 290 including the wireless link application 142, interfacing with middleware 295. A network stack 300, a miniport driver 305, soft-upper MAC 310, a lower-MAC hardware abstraction layer (HAL) 315 may further be provided in the architectural framework 280. Suitable conventionally available middleware and miniport drivers may be deployed in one embodiment based on a particular user platform environment and a wireless communication system.

The architectural framework 280 allows one or more wireless/wired network communication protocols (or any other workload that may be implemented in hardware and software implementable portions) to be hosted on the user platform 275, in such a way that the exact hardware/software workload partitioning may be adjusted depending on the capabilities of the host device 30 to either act as a station or an access point (such as other processing entities—an integrated digital signal processor (DSP), for example, or dedicated hardware features). ideally, the user platform 275 and the architectural framework 280 culminate in a “soft” implementation of desired parts of such protocols. In this manner, a particular protocol to be implemented such that at least one of regional variances and/or a wireless service vendor may be accounted for in software itself based on the link communication profile. For example, a wireless protocol that is supported by the user platform 275 may evolve with time (such as migration from 802.11b to 802.11a, e.g.) or that multiple simultaneous protocols may be supported (Bluetooth and 802.11b, e.g.) in one embodiment.

According to one operation consistent with an embodiment of the present invention, to undertake wireless connectivity for the communication interface 110, the programmable device 225 may interact with the wireless network interface 230a over a lower medium access control (LMAC) interface 335, exchanging control signals. Specifically, the wireless network interface 230a may include a radio frequency (RF) transceiver 340 for receiving and transmitting radio control and user communications. For digital processing of such radio communications, the wireless network interface 230a may further include a baseband analog-front-end (AFE) 342, in one embodiment. To control these radio communications for the access point 40, the wireless network interface 230a may include a lower medium access controller (LMAC) 344.

Using the device driver 195, the soft-upper MAC 310 may be incorporated into the host device 30 as shown in FIG. 2. The miniport driver 305, the soft-upper MAC 310, and the lower-MAC HAL 315 may communicate with the LMAC 344 through a host IO data link, i.e., via the LMAC interface 335 and the host I/O interface 105. The DMA engine 325 and the buffers 330 may be implemented as part of the programmable device 225 in one case.

Analyzing the computational, memory, data flow path, I/O bandwith, timing requirement of the user platform 275 and of the communication interface 110 may provide a functional partitioning of a wireless link provided in some embodiments. As a result, MAC layer operations are separated into software and hardware implementable portions. In particular, while the lower medium access controller 344 carries out the MAC operations in hardware, the soft-upper MAC 310 provides a host-based software reconfigureable functionality to select a particular wireless link without modifying the communication interface 110. In this way, some hardware including the communication interface 110 may support disparate wireless/wired network communication protocols associated with different wireless links on the host device 30. Of course, the exact division of the workload may be changed to fit a particular architecture and technology in some embodiments.

By substantially merging the existing 802.11a/b wireless LAN (WLAN) link (e.g., client network interface card (NIC), such as a PCMCIA card into the user platform 275, such as a PC platform (desktop, mobile or handheld devices, as few examples), a cost-effective implementation of a wireless link may be accomplished in one embodiment. Relatively higher performance (e.g., high speed, high bandwidth and low latency, with possibly quality of service (QoS) scheduling support) an input/output (IO) link between an (IO) unit and a system memory may be incorporated into a PC platform, supporting more than one wireless/wired network communication protocols and/or channels simultaneously (e.g. 802.11a, 802.11b, Bluetooth, cellular link), with separate analog front ends.

In most conventional PC platforms because of interrupt, IO limitations, memory latencies it is not possible to implement the MAC functionality on a host PC. Instead, based on a partitioning scheme as described above in one embodiment, the LMAC interface 335 may be coupled with a baseband PHY processing pipeline, handling the low latency packet transactions in dedicated hardware (e.g., a chip or a programmable streaming-oriented processor). While the operations (e.g., including the access point 40 functions) of the soft-upper MAC 310 may be performed at the host device 30, an interface across the soft-upper MAC 310 and lower MAC interface 335, i.e., for the middle MAC responsible for processing packets with medium latency constraints may be provided. In another case, the middle MAC may be implemented as a custom event scheduler or an embedded controller in some embodiments.

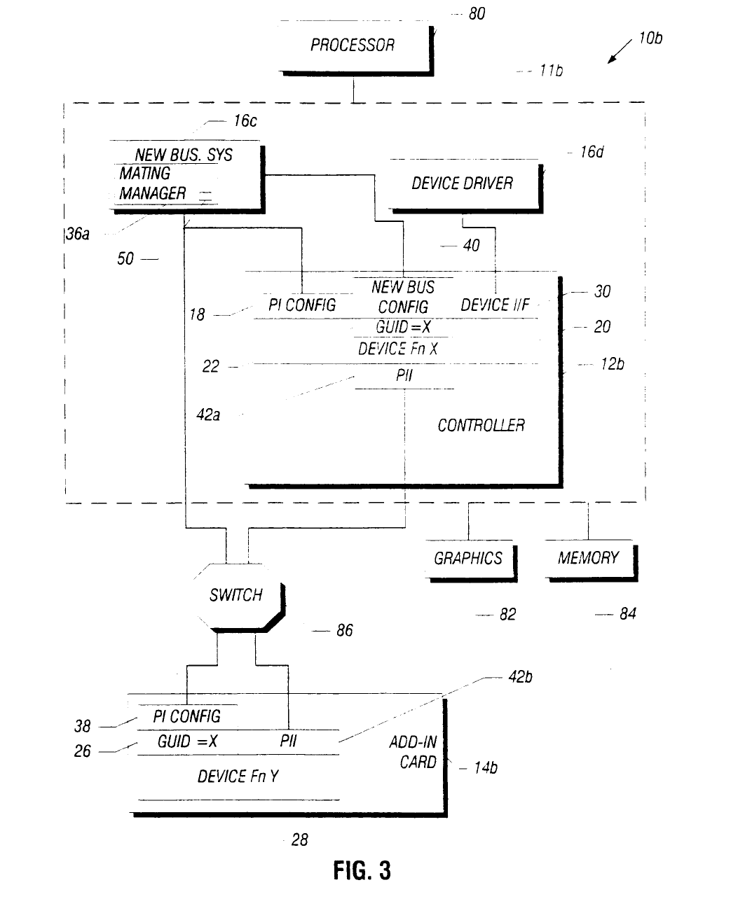

Turning to FIG. 3, to programmably reconfigure the programmable device 225, for the link communication profile 167a, as an example, control data may be received in an indication from the wireless link application 142 at the device driver 195, according to one embodiment of the present invention. However, some data communication may be provided with the wireless link application 142, in some embodiments of the present invention. In particular, the control data may include protocol and/or channel information for the link communication profile 167a corresponding to a wireless link that is being currently selected or identified. The link communication profile 167a determines one or more characteristics of wireless network communications on a communication medium 360 responsive to a particular setting in the programmable device 225.

To provide such a programmability and reconfigurability within the host device 30, the programmable device 225 may include a protocol module 320 and a chip register 322 in one embodiment. An example of the chip register 322 is a shift register. In one embodiment, the set of buffers 330 may use a hardware adaptation layer (HAL) interface 362 connected to the communication medium 360. In a receive path, a receiver (Rx) module 364 may receive wireless network communications from the HAL interface 362. Responsive to such wireless network communications, the receiver module 364 may operate according to protocol logic 366. Likewise, a transmission (Tx) module 368 may be deployed in a transmission path to the HAL interface 362, communicating with the device driver 195 under the control of the protocol logic 366.

Consistent with one embodiment of the present invention, the DMA engine 325 may incorporate a queue manager 370 and a buffer manager 375. In one embodiment, while the queue manager 375 may handle the transmission/reception of one or more data packets within the wireless network communications over the communication medium 360, the buffer manager 370 may controllably operate the buffers 330. Furthermore, the chip register 322 may be n-bits wide where “n” may depend upon a particular application. According to one embodiment, the chip register 322 may include 16-bits which may be programmable set either to a high logic (e.g., “1” bit value) or to a low logic (e.g., “0” bit value based on the link communication profile 167a. That is, when a different wireless link is selected at the wireless link application 142, e.g., the link communication profile 167b, a different set of bits or different number of bits may be set in the chip register 322.

A PC may be merged with a variety of wireless communications technologies, implementing the functionality of a WLAN MAC as a set of software functions in a processor-based, such as the host device 30. As set forth above, the WLAN MAC may be divided into separate sub-layers (upper MAC, middle MAC, and lower MAC) based on the latency requirements of handling different events and protocol signaling, in addition to the processing and memory bandwidth requirements.

Specifically, in this embodiment, the soft-upper MAC 310 may interface with the device driver 195 that includes long latency operations. The lower-MAC 344 may interface with the physical layer that includes most of the fast turnaround operations. The middle MAC functionality may be merged into either the soft-upper MAC 310 or the lower-MAC 344; or alternatively, implemented in a separate embedded micro-controller or as a custom-made hardware scheduler.

To carry out radio communications, an analog-front-end (AFE) including an analog radio antenna, a tuner and an analog-to-digital converter may be provided in one embodiment. There may be several of the AFEs, which may be tailored to a different type of communications. In one embodiment, a significantly reduced cost of manufacturing for a PC with wireless LAN support and memory requirements for the communication interface 110 may be provided by either reducing or eliminating the use of the system memory 140 and buffers 330 in the programmable device 225 that may be located within a PC chipset. For instance, a personal computer may establish a wireless LAN link to a wireless-enabled network communication device, such as the access point 40 using the communication interface 110 based on a standard as set forth in a specification entitled “Personal Computer Memory Card International Association (PCMCIA) Standard,” Version 2.1, published in 1993.

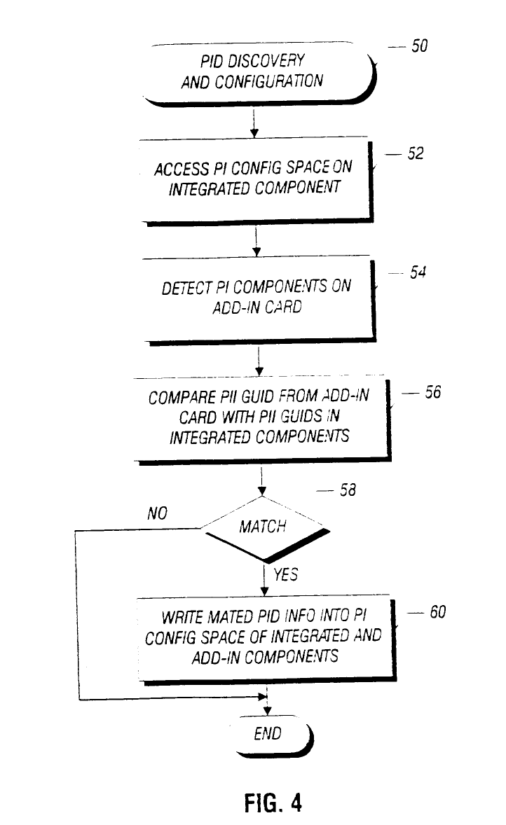

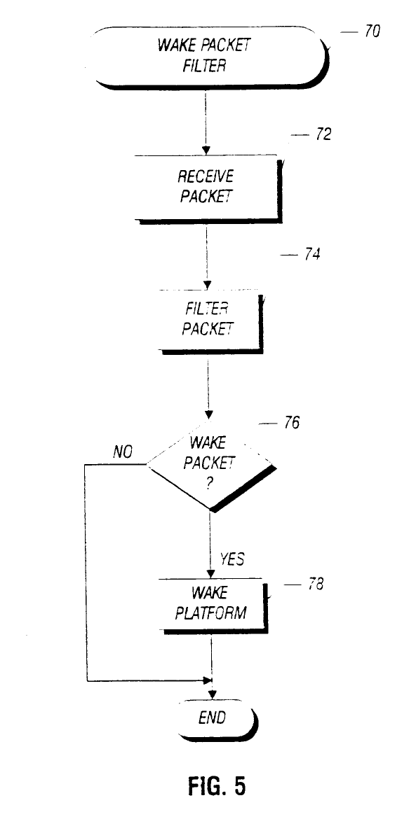

Referring to FIG. 4A, a link profile, e.g., the link communication profile 167a may be identified for a network communication device, such as the host device 30 (FIG. 1), at block 380 according to one embodiment of the present invention. At block 382, a workload associated with a wireless link to a wireless-enabled network communications device, e.g., the access point 40 may be determined based on the link communication profile 167a (e.g., 802.11a, 802.11b, Bluetooth, cellular link). In some embodiments, the workload may incorporate one or more wireless/wired network communication protocols or channel that may be supported via hardware and software implementable portions. Both the identification of the link profile and determination of the workload may be handled by the wireless link application 142 in some embodiments of the present invention. Based on a selected link profile, the workload may be partitioned into software and hardware implementable portions, e.g., within the host device 30, at block 384.

A check of a link profile may determine a current link profile at diamond 388. If the current link profile is determined to be another link profile different than the link profile selected at block 380, a revised partitioning of the workload may be desired. As a result, the workload may be set up at block 390 based on the current link profile. Conversely, if the current link profile is determined to be same as the link profile selected at block 380, for a wireless communication a corresponding active signal may be detected at block 392. If a wireless communication is indicated to be present at diamond 394, the wireless communication may be appropriately communicated over the wireless link based on the current link profile, at block 396 and the flow ends. Otherwise, if a wireless communication is not detected at diamond 395, the embodiment.

Referring to FIG. 4B, the communication interface 110 for the drivers 100 may detect a wireless communication at block 410. That is, features of the wireless communication indicating a type of wireless communication protocol and/or channel may be derived, i.e., channel allocation may be detected at block 411. Further, from the wireless communication, in one embodiment, the device driver 195 may derive a wireless link profile at block 412.

A check at diamond 414 may determine whether or not support is available for the wireless link profile derived from the wireless communication. When support is unavailable for the wireless link profile, the flow ends. However, if support is indicated to be available, protocol support availability may be checked at diamond 415 in accordance with one embodiment of the present invention.

A check at the diamond 415 may indicate whether or not protocol support is available corresponding to the wireless network communication link. For appropriately receiving the wireless communication, the availability of the protocol support may be determined, in one case. At block 416, if protocol support is determined to be available, one or more attributes associated with the wireless-enabled network communication device, e.g., the host device 30 may be determined. Examples of the device attribute include a particular type of available analog front end (AFE), chipset and drivers. At block 418, corresponding to the wireless network communication link, the software and hardware implementable portions may be configured within the wireless-enabled network communication device based on the attributes.

At block 420, the wireless communication may be completed if appropriate protocol support and channel is found to be available. In case, if either the protocol is determined to be unsupportable at the diamond 415 or the channel is indicated to be unavailable at block 411, the wireless communication may not be completed and the flow ends.

In one embodiment, software based implementation of wireless standards allow for shipping the same hardware platform world-wide for the host device 30, having the appropriate software conform to the local communications standards. Additionally, this may allow for dynamic adaptation of the host device 30 as a user moves from one geo-political zone to another. Such a software based implementation may also support multiple simultaneous complementary protocols (i.e. 802.11a and Bluetooth). Also, the software based implementation is scaleable. As more and more processor 125 (FIG. 1) power becomes available, the software and hardware partitioning may be adjusted in one embodiment. Therefore, a customer may upgrade from one protocol to another without changing and/or needing additional hardware in some embodiments.

In another embodiment, because modulation, demodulation, channel coding, and other basic radio communication functions may be implemented in software, each may be desirably changed to allow a single unit to support multiple radio protocols. Moreover, the programmability and reconfigurability allow for channel adaptation, leading to a relatively better network throughput and regional adaptation while dealing with differences in the standards that exist around the world. Software protocols may allow product feature or performance updates and/or upgrades on-the-fly, in the face of the ever-changing standards and application usage for some embodiments. By tightly coupling the MAC into an existing operating system (OS) network stack, appropriate information to upper layers may be provided for better utilization of the wireless link.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
partitioning a workload associated with a first wireless link into software and hardware implementable portions based on a link communication profile; and
in response to a different link communication profile, configuring said workload to simultaneously support a second wireless link different than the first wireless link.

2. The method of claim 1 further comprising:
identifying the link communication profile;
determining the workload associated with the wireless link; and
programming a programmable device based on the link communication profile and the workload.

3. The method of claim 1 further comprising:
in response to a wireless communication, distributing functionality of the software and hardware implementable portions within at least one of the device or an access point to a network based on the link communication profile; and
dynamically adapting the at least one of the device or the access point by changing at least one attribute thereof based on said functionality.

4. The method of claim 3 further comprising:
extracting protocol and channel information from the wireless communication; and
cooperatively handling one or more wired protocols with one or more wireless communication protocols based on the protocol and channel information.

5. The method of claim 3 further comprising selectively providing the wireless communication on one or more communication channels in the wireless link, said one or more communication channels to operate in a different frequency range.

6. The method of claim 3 further comprising:
automatically detecting the wireless communication over the wireless link;
providing a first portion of a medium access control protocol in the software implementable portion; and
providing a second portion of the medium access control protocol in the hardware implementable portion.

7. The method of claim 4 further comprising implementing at least one wireless communication protocol of said one or more wireless communication protocols in the software implementable portion to account for at least one regional variance and a wireless service vendor based on the link communication profile.

8. The method of claim 4 further comprising simultaneously supporting said one or more wireless communication protocols for the device.

9. The method of claim 8 further comprising providing a different analog wireless interface in the device for a different wireless communication protocol of said one or more wireless communication protocols.

10. The method of claim 4 further comprising:
in response to the different link communication profile, reprogramming the programmable device to accommodate said one or more wireless communication protocols for the wireless communication over the wireless link; and
adjusting the software and hardware implementable portions of the workload based on the programmable device to provide a flexible wireless communication platform out of a personal computer.

11. An apparatus comprising:
a communication interface operably coupled to a controller to wirelessly communicate over a wireless link to a network; and
a storage device, operably coupled to said communication interface, storing a driver that partitions a workload associated with the wireless link into software and hardware implementable portions based on a link communication profile and configures said workload to simultaneously support another wireless link different than the wireless link responsive to a different link communication profile.

12. The apparatus of claim 11, further comprising a programmable device to adapt the communication interface in response to an indication from said driver.

13. The apparatus of claim 12, further comprising:
a wireless network interface operably coupled to said programmable device; and
a memory storing an application that causes said controller to operate as a medium access controller that enables said driver to generate the indication.

14. The apparatus of claim 13, said programmable device comprising logic controlling one or more configurable bits.

15. The apparatus of claim 14, said driver including a device driver to enable programming of said one or more bits.

16. An apparatus comprising:
a communication interface operably coupled to a controller to wirelessly communicate over a first wireless link to a local area network;
a dipole antenna operably coupled to said communication interface; and
a storage device, operably coupled to said controller, storing a driver that partitions a workload associated with the first wireless link into software and hardware implementable portions based on a link communication profile and configures said workload to simultaneously support a second wireless link different than the first wireless link responsive to a different link communication profile.

17. The apparatus of claim 16, further comprising a wireless network interface operably coupled to a programmable device.

18. The apparatus of claim 17, further comprising:
a device driver to generate an indication in response to a request from said communication interface; and
a protocol module and a register to adapt the wireless network interface in response to the indication from said device driver.

19. The apparatus of claim 18, said programmable device further comprising logic controlling one or more configurable bits.

20. The apparatus of claim 19, further comprising a memory storing an application that causes said controller to operate as a medium access controller that enables said device driver to provide the indication.

21. An article comprising a medium storing instructions that, when executed result in:
partitioning a workload associated with a first wireless link into software and hardware implementable portions based on a link communication profile; and
in response to a different link communication profile, configuring said workload to simultaneously support a second wireless link different than the first wireless link.

22. The article of claim 21, comprising a medium storing instructions that, when executed result in:
identifying the link communication profile;
determining the workload associated with the wireless link; and
programming a programmable device based on the link communication profile and the workload.

23. The article of claim 21, comprising a medium storing instructions that, when executed result in:
in response to a wireless communication, distributing functionality of the software and hardware implementable portions within at least one of the device or an access point to a network based on the link communication profile; and
dynamically adapting the at least one of the device or the access point by changing at least one attribute thereof based on said functionality.

24. The article of claim 23, comprising a medium storing instructions that, when executed result in:
extracting protocol and channel information from the wireless communication; and
cooperatively handling one or more wired protocols with one or more wireless communication protocols based on the protocol and channel information.

25. The article of claim 23, comprising a medium storing instructions that, when executed result in selectively providing the wireless communication on one or more communication channels in the wireless link, said one or more communication channels to operate in a different frequency range.

26. The article of claim 23, comprising a medium storing instructions that, when executed result in:
automatically detecting the wireless communication over the wireless link;
providing a first portion of a medium access control protocol in the software implementable portion; and
providing a second portion of the medium access control protocol in the hardware implementable portion.

27. The article of claim 24, comprising a medium storing instructions that, when executed result in implementing at least one wireless communication protocol of said one or more wireless communication protocols in the software implementable portion to account for at least one regional variance and a wireless service vendor based on the link communication profile.

28. The article of claim 24, comprising a medium storing instructions that, when executed result in simultaneously supporting said one or more wireless communication protocols for the device.

29. The article of claim 28, comprising a medium storing instructions that, when executed result in providing a different analog wireless interface in the device for a different wireless communication protocol of said one or more wireless communication protocols.

30. The article of claim 24, comprising a medium storing instructions that, when executed result in:
in response to the different link communication profile, reprogramming the programmable device to accommodate said one or more wireless communication protocols for the wireless communication over the wireless link; and
adjusting the software and hardware implementable portions of the workload based on the programmable device to provide a flexible wireless communication platform out of a personal computer.
